(19) United States
(12) Patent Application Publication
(10) Pub. No.: US 2026/0336205 A1
(43) Pub. Date: Oct. 29, 2026

(54) ADDITIVE PRODUCTION PROCESS WITH MATERIAL REINFORCED WITH CONTINUOUS FIBER BY MEANS OF VIBRATING DEPOSITION MEANS AND RELATED APPARATUS

(71) Applicant: ROBOZE S.P.A., Bari (IT)

(72) Inventors: Alessio LORUSSO, Bari (IT); Matteo REGE', Bari (BA) (IT); Antonio SAPONARA, Turi (BA) (IT); Simone CUSCITO, Bari (BA) (IT)

(21) Appl. No.: 19/124,388

(22) PCT Filed: Oct. 24, 2023
(86) PCT No.: PCT/IB2023/060707

§ 371 Date: Apr. 25, 2025

(30) Foreign Application Priority Data
Oct. 27, 2022 (IT) 102022000022179

(51) Int. Cl. B29C 64/194; B29C 64/165; B29C 64/295; B33Y 10/00; B33Y 30/00

(52) U.S. Cl. CPC B29C 64/194; B29C 64/165; B29C 64/295; B33Y 10/00; B33Y 30/00

(57) ABSTRACT

An additive production process for 3D printing with material reinforced with long or continuous fiber, involves: a first step of preheating a composite filament (0) made of polymeric material, reinforced with long or continuous fiber, to a temperature sufficient to soften but not to melt the polymeric matrix, wherein said preheating is implemented by a specific preheating unit; a second step of localized heating and deposition wherein both thermal and mechanical energy is supplied to the material, by means of suitable heating means and by applying a pulsed compacting force, and the material thus softened is then deposited by means of a welding compacting unit. The thermal energy supplied by the welding compacting unit is responsible for the complete melting of the polymeric matrix while the mechanical energy, in the form of vibrations, involves a welding of the layer of material thus fluidized to the previous layer or to the substrate present on the printing plane. The apparatus for implementing the aforesaid process involves, in combination: a unit for preheating the filament (0) made of composite material reinforced with long or continuous fiber; and a welding compacting unit (5), placed coaxially downstream of the preheating unit, which is provided with an own heating element.

The present invention relates to the sector of 3D printing of three-dimensional items, with particular reference to the issues relating to the printing of filaments made of composite material, reinforced with continuous fibers.

More specifically, the invention relates to an innovative additive production process (AM=Additive Manufacturing) of the Fused Filament Fabrication type (FFF) with unidirectional continuous fiber reinforcement. This production process involves the deposition of overlapping layers of polymer reinforced with a continuous and non-continuous fiber, to produce three-dimensional items (which may therefore consist of layers of reinforced polymer alternating with layers of non-reinforced polymer). The material extruded in such process is, by all means, a composite material where the polymer is the matrix phase.

The discontinuous nature of the process involves, first of all, the existence of an interface between consecutive (overlapping) layers, which limits the mechanical performance of the component. This is due to the fact that the previously deposited layer, which is the substrate on which the subsequent layer is extruded, is at a temperature lower than the melting temperature of the polymer. If the substrate layer were not solid it would, in fact, be impossible to maintain control and accuracy in the geometries produced. This temperature difference causes a defective welding of the layers, resulting in reduced mechanical properties.

Secondly, in currently known 3D printing technologies, the layers are made from filaments of composite material extruded by means of a nozzle with a circular section, with a relative movement with respect to the printing plane: therefore, they have a section which is substantially elliptical. The impossibility of filling a three-dimensional space with filaments having an elliptical section involves the presence of a porosity existing at the interface between consecutive layers. This porosity limits the continuity of the resistant section and therefore further reduces the mechanical properties of the material.

It is one of the objects of the present invention to resolve the conventional issues of the additive production of composite materials according to an FFF process: both the defective welding between overlapping layers as well as the porosity of the material which forms the printed product. This result is achieved by means of an innovative apparatus and an additive production process which involves the preheating of a composite filament of polymeric material, reinforced with long and/or continuous fiber, up to a temperature sufficient to soften the polymeric matrix; said heating is applied by a special preheating unit and the material thus softened is then deposited not directly, but through a welding compacting unit, which is configured to provide the material with both thermal and mechanical energy, by means of special heating means and by means of means for applying a pulsed compacting force. In consideration of this, the present invention provides that the composite filament of polymeric material coming out of the preheating unit directly enters the welding compacting unit.

A variant of the invention provides that said compacting unit supplies a share thereof of thermal energy by means of the dissipation of mechanical vibrational energy, for example at ultrasonic frequency.

According to a peculiar feature of the present invention, the thermal energy supplied by the welding compacting unit is responsible for the complete melting of the polymeric matrix while the mechanical energy, in the form of pulsating force, involves a welding of the layer of material thus fluidized to the previous layer or to the substrate present on the printing plane. The effect of the pulsed (vibrating) compacting force, where the polymer has the lowest possible viscosity due to the thermal energy introduced by the welding compacting unit itself, causes both a very effective welding between consecutive layers as well as a reduction in the internal porosity of the printed material.

The printing technology of the present invention, based on a preheating necessarily followed by a second localized heating during the welding onto the lower layer, presents further advantages with respect to the prior art: firstly, the fact that the matrix phase is not completely melted in the preheating channel, it involves a lesser friction and a greater ease of movement of the filament along the feeding channel existing in the preheating unit itself.

Secondly, during the repositioning movements and/or during the periods of inactivity of said printing head, the material is kept inside the preheating unit at a temperature lower with respect to what usually occurs in extruders of the prior art. Advantageously, this causes a lesser thermal degradation of the matrix phase.

Finally, the fact that the matrix is only softened in the feeding channel present in the preheating unit involves that the matrix is extruded simultaneously with the continuous reinforcing fiber and therefore exactly at the same speed thereof: thereby, a printing process is obtained which is devoid of under/over-extrusions.

It is also interesting to note that if the welding compacting unit is made to vibrate at ultrasonic frequencies, a transfer of a high quantity of mechanical energy is created, which is converted into thermal energy through dissipative phenomena within the composite material. This thermal energy is responsible for a further rise in the temperature of the substrate, which positively contributes to the effectiveness of the welding between the layers.

Therefore, one of the primary advantages of the invention is the additive deposition of a material having a high mechanical performance associated with a reduced porosity of the printed piece.

3D printing techniques are already known which concern the additive production of composite materials through a system of the FFF type. In these cases, the melting of the polymer occurs exclusively and entirely in a specially engineered extruder. This involves that the extruded filament is not at the maximum temperature reached when it is deposited on the substrate layer, since the newly extruded filament cools very quickly once it comes out of the nozzle.

The present invention, on the contrary, provides for a preheating, where the composite material is heated up to a temperature sufficient to soften the polymeric phase, in which the material thus softened is then treated by the welding compacting unit which simultaneously applies thermal energy and mechanical energy, carrying out the welding where the filament is at the maximum temperature and, therefore, with the polymeric matrix at the minimum viscosity.

Other known printing technologies are related to the additive production of composite materials through an additive production system of the FFF type, in which the melting of the polymer occurs exclusively and entirely in a specially engineered extruder, having a nozzle suitable for stretching the newly extruded filament. In these cases, said stretching pressure is applied by means of an element of the printing head, which may be the nozzle or a rounded protuberance in charge of the stretching.

Unlike such known systems, the present invention provides a preheating unit, followed by a welding compacting unit which is preferably provided with a heating element thereof or an element providing thermal energy by dissipating vibrational energy. This causes that the welding process between layers occurs at the point in which the polymeric matrix has the lowest viscosity, while the compacting force applied by the vibrations of the compacting unit is dissipated through the underlying layers. This causes a more complete and effective welding with respect to existing methods.

A better understanding of the invention will be achieved from the present detailed description and with reference to the accompanying drawings showing, by way of a non-limiting example, a preferred embodiment.

In the drawings:

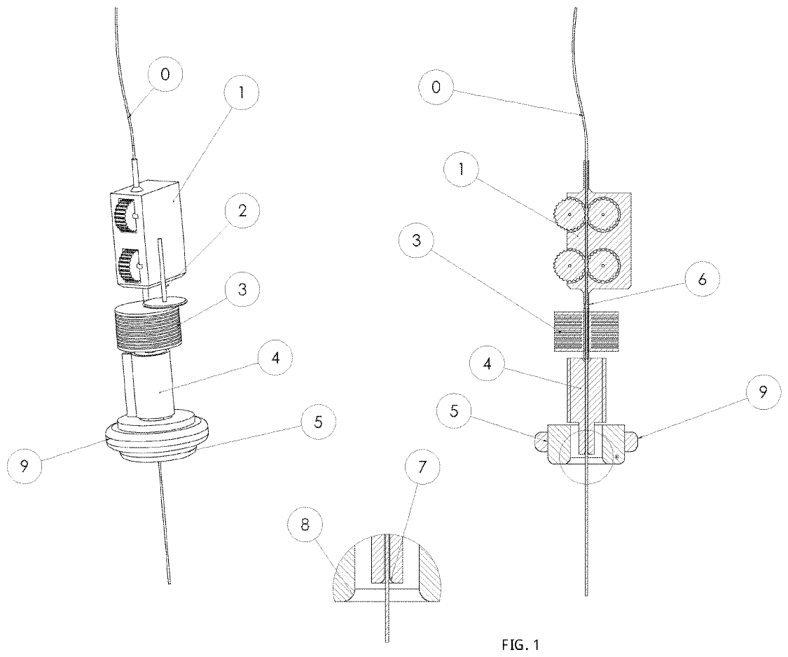

FIG. 1 shows a general diagram of the apparatus for implementing the additive production process according to the invention, in which the reinforced polymer filament (0) is pushed by the feeding device (1) through a heat sink (3) inside a heated element (4); subsequently, the filament (0) leaves the preheating unit and passes through the welding compacting unit (5); the edges of exit of the filament from the individual components are contoured (7, 8), so as to ensure that the filament itself is not damaged during the extrusion process.

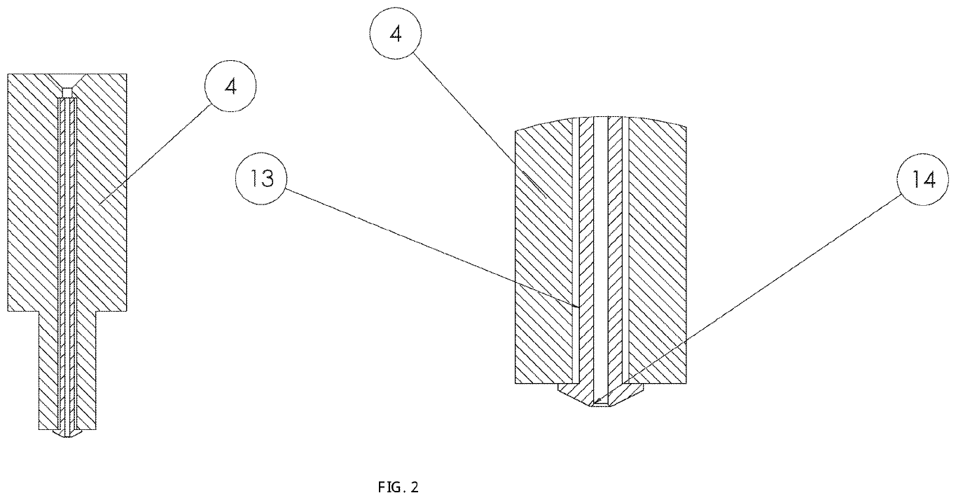

FIG. 2 shows a detail of an alternative embodiment of the preheating unit in which the heated element (4) houses a straw therein provided with a nozzle (13) which has a contour near the nozzle (14) thereof.

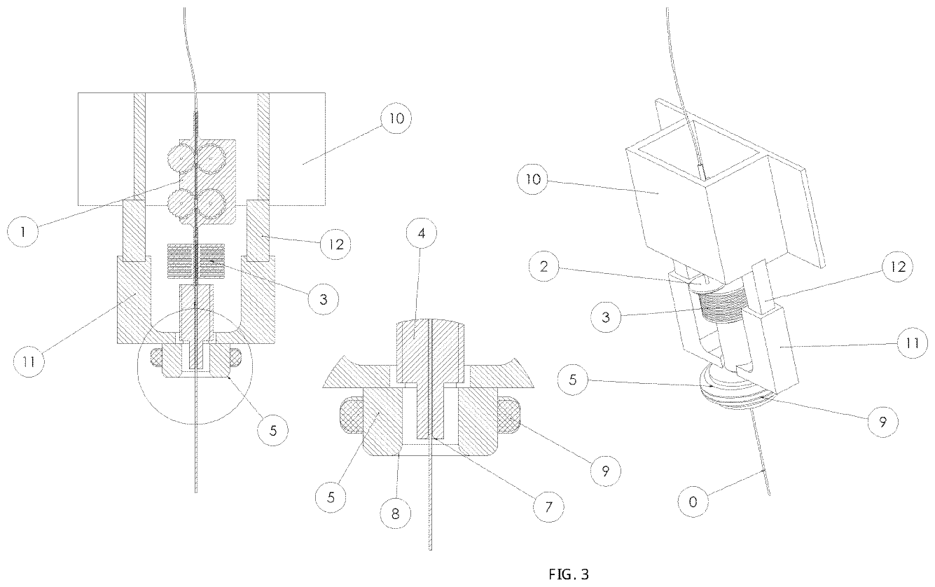

FIG. 3 shows an alternative embodiment of the apparatus for implementing the additive production process in which the welding compacting unit (5) is made to vibrate by actuators (12) connected to the printer structure by means of a fixed unit (10).

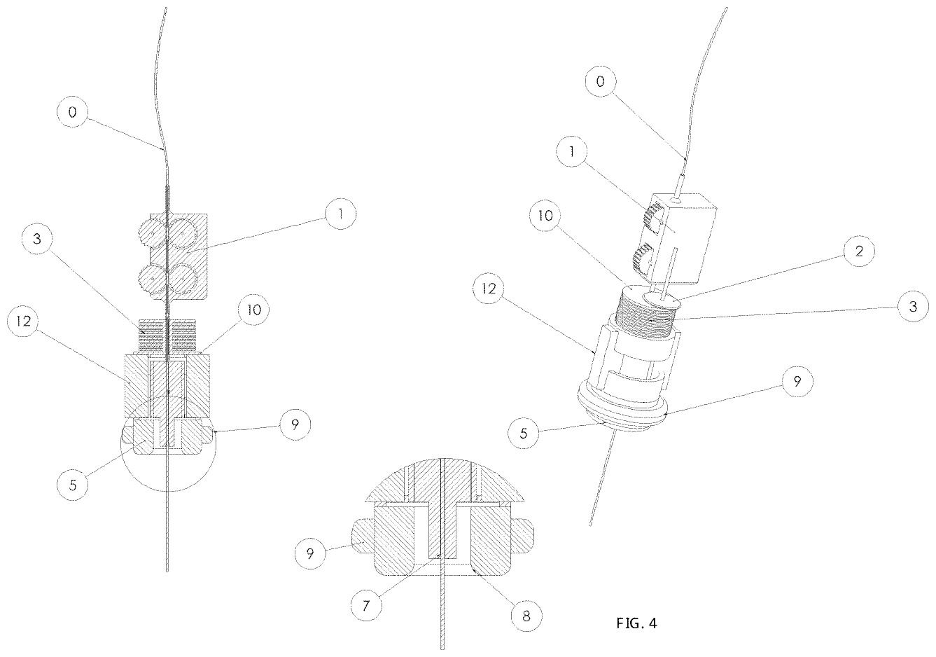

FIG. 4 shows a further alternative embodiment of the apparatus for implementing the additive production process in which the welding compacting unit (5) is made to vibrate by actuators (12) directly connected to the preheating unit by means of a fixed unit (10).

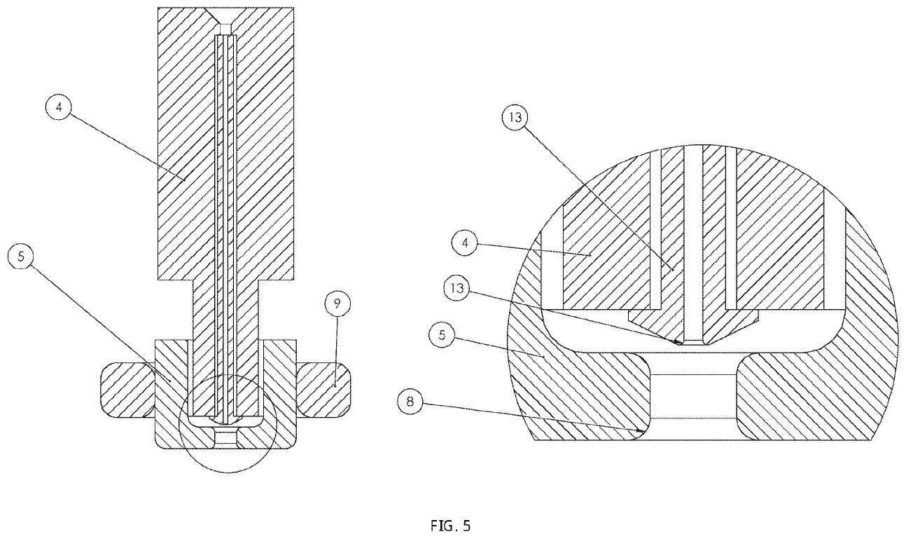

FIG. 5 shows a detail of the preheating unit and the welding compacting unit.

The apparatus for implementing the process object of the present invention includes a unit for preheating the filament made of composite material up to a temperature at which the matrix phase is softened, to obtain that the material is deformable along the section existing between the preheating unit and the welding compacting unit, so as to be arranged parallel to the surface of the substrate, being it the printing plate or the previously deposited layer.

Once the material is arranged parallel to the surface of the substrate, the thermo-mechanical effect applied by the welding compacting unit causes the welding of the material onto the substrate itself. According to a peculiar feature of the invention, the compacting unit, which is a separate and distinct element from the preheating unit, provides the material with the last portion of thermal energy necessary for melting the filament and welding it onto the substrate. This occurs exactly where it is needed, i.e., at the welding point.

As already mentioned, the invention is based on an additive deposition process of the Fused Filament Fabrication type (FFF), which uses composite materials having a polymeric matrix (such as, for example, but not exclusively, the thermoplastic one) reinforced with a long fiber made of reinforcing material, such as, for example, glass fiber, aramid fiber, carbon fiber, natural fiber, Zylon fiber or basaltic fiber.

The process may also be used with a polymeric matrix containing optical fibers and/or conductive fibers. The printing system, in this case, is configured to carry out a continuous deposition without cuts within a layer, in which the two ends of the optical or conductive fiber are left outside the part, so that it is then possible to connect the fiber to the source.

With reference to FIG. 1, the composite material, in the form of a filament (0), is supplied to the printing head by a loading device (1). The filament has a minimum transverse dimension of 0.2 mm and, preferably but not exclusively, a maximum dimension of 1.5/2 mm.

It is worth noting that an additive manufacturing process, using a filament (0) reinforced with long/continuous fiber, involves that—during the printing—the deposition group is mechanically constrained to the item being printed by means of the reinforcing fiber within the filament itself. For this reason, in order to allow the movement of the deposition group with respect to the printing plane during the repositioning movements, cutting means (2) for cutting the reinforced filament (0) are provided upstream of the preheating unit and downstream of the loading device (1).

The filament (0) is then pushed by the loading device (1) inside the preheating unit, which consists of a heat sink (3) and of at least one heated element (4) by means of resistors or inductive elements or elements of another known type, in which said heated element is controlled by one or more control circuits. The heat sink (3) and the heated element (4) are aligned and placed in sequence and have an internal channel (6) within which the composite filament (0) slides. This preheating unit is configured to heat the material up to a temperature at which the matrix phase is softened. Advantageously, this preheating allows the filament (0), which under normal conditions would be rigid, to be deformed when exiting the preheating unit. To this end, the preheating unit preferably ends with a chamfer (7) or a flare, so as to facilitate the exit and bending of the filament (0) made of composite material, without it suffering damage due to the rubbing thereof on sharp edges.

The internal channel (6) of the preheating unit is preferably, but not exclusively, configured to contain an interchangeable straw (13), so as to easily replace it to use filaments of different diameters or in the event of erosion thereof caused by the use of abrasive materials. Also in this case, at the end of the straw (13) there is a chamfer/flare (14) having the same function as the chamfer/flare (7) described above. A non-limiting example of such configuration is shown in FIG. 2.

As mentioned, downstream of the preheating unit there is a welding compacting unit (5), which is coaxial but not integral with the preheating unit. Such welding compacting unit (5) is in charge of welding the preheated filament (0) onto the surface of the substrate, being it the printing surface or the upper surface of the part being printed. One of the peculiar features of the welding compacting unit (5) is that of being an active unit distinct from the preheating unit.

The welding compacting unit (5) is defined as active since it has at least one heat source (9) suitable for the heating thereof, with an adequate thermal control circuit.

The object of the welding compacting unit (5) is therefore twofold:
providing the filament (0) coming out of the preheating unit with the last portion of the thermal energy necessary to bring the matrix phase up to a melting temperature,
compressing the filament (0) onto the surface of the substrate.

This configuration involves the great advantage of having the polymeric matrix of the filament (0) made of composite material at a temperature which is greater than or equal to the melting temperature, precisely at the welding area. The welding compacting unit (5) has an internal chamfer/flare (8) to prevent the relative motion between the welding compacting unit (5) and the filament (0) from damaging the filament itself if there were sharp edges.

The above compression/compacting occurs by means of a mechanical vibration transmitted by at least one actuator (12) to the welding compacting unit (5) itself. The actuator (12) provides a reciprocating motion in the axial direction with respect to the preheating unit and to the welding compacting unit (5). In a variant (not shown), said reciprocating motion has at least one component in the axial direction.

In this regard, it is interesting to note that the amplitude of the oscillations of the welding unit, if adequately modulated, allows the pressing of the newly deposited material when the latter shows the lowest viscosity thereof, resulting in a reduction of the porosity caused by the voids existing between the adjacent layers.

A further peculiarity of the invention consists in the fact that the vibration of the welding compacting unit (5) may be controlled in amplitude and/or frequency, so as to optimize the welding process of the filament (0) during the deposition on the substrate. Said optimization may occur as a function of the printing parameters (layer height), of the local features of the product being printed (thin walls with many details or solid items), or of the materials used for printing (matrix phases with different viscosity, different fiber-matrix ratios).

Additionally, it is worth noting that the welding compacting unit (5) may be controlled to vibrate at subsonic or ultrasonic frequencies.

The mechanical connection of the actuator (12) to the part of the printer structure which is in charge of moving the deposition unit may be achieved in different ways, shown by way of example in FIG. 3 and FIG. 4. In any case, such actuator is tied to the printing head or to the carriage moving it.

In FIG. 3, the fixed part (10) of the welding compacting unit (5) is constrained to the carriage moving the deposition group. The motion of the actuator/actuators (12) is transmitted to the welding compacting unit (5) by means of a mechanical connection element (11)

In FIG. 4 however, the fixed part (10) of the welding compacting unit (5) is directly constrained to the preheating unit.

A variant of the preferred embodiment described so far, shown in FIG. 5, provides a welding compacting unit (5) having the central opening, placed downstream of the preheating unit, which is narrower than in the previous case, while the other system components, as well as the thermal control thereof, remain unchanged. This variant allows greater precision in the positioning of the filament reinforced with continuous fiber during the deposition thereof.

KEY

| Element | Description |
|---|---|
| 0 | Composite filament reinforced with long/continuous fiber |
| 1 | Feeding device |
| 2 | Cutting device |
| 3 | Heat sink of the preheating unit |
| 4 | Heated element of the preheating unit |
| 5 | Welding compacting unit |
| 6 | Internal channel |
| 7 | Chamfer/flare inside the exit from the preheating unit |
| 8 | Chamfer/flare inside the exit from the welding unit |
| 9 | Heating element of the welding unit |
| 10 | Fixed part of the vibrating system |
| 11 | Mechanical connection element between actuator and welding |
| | compacting unit |
| 12 | Actuator/s |
| 13 | Straw with nozzle |
| 14 | Chamfer/flare inside the straw |

1. An additive production process for 3D printing with material reinforced with long or continuous fiber, characterized in that it involves, in combination, both the following steps:
a first step of preheating a composite filament (0) made of polymeric material, reinforced with long or continuous fiber, to a temperature sufficient to soften but not to melt the polymeric matrix;
a second step of localized heating and deposition, wherein both thermal and mechanical energy is supplied to said filament (0), by means of suitable heating means and by means for applying a pulsed compacting force, and the material thus softened is then deposited;
wherein said first preheating step is implemented by a specific preheating unit, and wherein said second localized heating and deposition step is implemented by a specific welding compacting unit (5);
wherein said preheating unit and said welding compacting unit operate simultaneously and the filament (0) exiting the first unit enters the second unit, thus obtaining that the thermal energy supplied during the second step by the welding compacting unit is responsible for the complete melting of the polymeric matrix while the mechanical energy, in the form of vibrations, involves a welding of the layer of material thus fluidized to the previous layer or to the substrate present on the printing surface.

2. An apparatus for implementing the process according to claim 1, characterized in that it involves, in combination:
a unit for preheating the filament (0) made of composite material reinforced with long or continuous fiber;
a welding compacting unit (5), placed downstream of the preheating unit and coaxially thereto, which is provided with an own heating element;
wherein said preheating unit and said welding compacting unit are configured to operate simultaneously and so that the filament (0) exiting the first unit enters the second unit, and wherein said apparatus is configured so that the welding between deposited layers occurs at the welding area in which the polymeric matrix has the lowest viscosity, i.e. with the polymeric matrix of the filament (0) having a temperature greater than or equal to the melting temperature thereof, while the compacting force applied by the vibrations of the compacting unit is dissipated through the underlying layers.

3. An apparatus according to claim 2, characterized in that said preheating unit is configured to preheat the filament (0) made of composite material up to a temperature at which the matrix phase is softened, to obtain that the material is deformable along the section existing between the preheating unit and the welding compacting unit (5), to be arranged parallel to the surface of the substrate, being it the printing plane or the layer of material previously deposited.

4. An apparatus according to claim 3, characterized in that the welding compacting unit (5), which is a separate and distinct element from the preheating unit, has at least one heat source (9) with an adequate thermal control unit which supplies the material with the last portion of thermal energy necessary for melting the filament and for the welding thereof to the substrate exactly where it is needed, i.e., at the welding point; thus obtaining that the thermo-mechanical effect applied by the welding compacting unit (5) determines the welding of the material to the substrate itself.

5. An apparatus for implementing the process according to claim 1, characterized in that it involves, in combination:
a unit for preheating the filament (0) made of composite material reinforced with long or continuous fiber;
a welding compacting unit (5), placed downstream of the preheating unit and coaxially thereto, which is provided with means for supplying the last portion of thermal energy to the composite material by dissipating mechanical energy into thermal energy;
wherein said preheating unit and said welding compacting unit are configured to operate simultaneously and so that the filament (0) exiting the first unit enters the second unit, and wherein said apparatus is configured so that the welding between layers occurs at the welding area in which the polymeric matrix has the lowest viscosity, i.e. with the polymeric matrix of the filament (0) having a temperature greater than or equal to the melting temperature thereof, while the compacting force applied by the vibrations of the compacting unit (5) is dissipated through the underlying layers.

6. An apparatus according to claim 5, characterized in that said means for supplying the last portion of thermal energy to the composite material, by dissipating mechanical energy into thermal energy, consist of operating means of the welding compacting unit (5) configured to make it vibrate at ultrasonic frequencies.

7. An apparatus according to claim 2, characterized in that said welding compacting unit (5) is configured to carry out a modulation of the vibration amplitude which, associated with the reduction of the viscosity of the polymeric matrix in the welding area, involves a reduction of the porosity caused by the voids existing between the adjacent layers.

8. An apparatus according to claim 2, characterized in that said heating means of the welding compacting unit consist of means for supplying thermal energy by dissipating high-frequency vibrational mechanical energy.
